(19) United States
(12) Patent Application Publication
(10) Pub. No.: US 2007/0188345 A1
(43) Pub. Date: Aug. 16, 2007

(54) Multiple access broadband wired access system with discontinuous mobility and method thereof

(76) Inventor: Jun Yu, Shenzhen (CN)

Correspondence Address: MATTHIAS SCHOLL, 14781 MEMORIAL DRIVE, SUITE 1319, HOUSTON, TX, 77079, US

(21) Appl. No.: 11/572,845

(22) PCT Filed: Jul. 28, 2005
(86) PCT No.: PCT/CN05/01143

§ 371 Date: Jan. 29, 2007

(30) Foreign Application Priority Data
Jul. 30, 2004 (CN) 200410050890.3

(51) Int. Cl. G01V 3/00

(52) U.S. Cl. 340/854.9

(57) ABSTRACT

We herein provide a multiple access broadband wired access system with discontinuous mobility, and the method thereof, applicable to the wired access communication technology field. The wired access system includes an end user access device, an access line, and an end office access device. Features of the invention include supporting discontinuous mobility, multiplexing, and multiple access broadband access. It thus overcomes various disadvantages of the wired access technology, such as fixing, stillness, separation, dedication, and so on, and increases the economic benefit of wired access communication.

### FIELD OF THE INVENTION

The invention relates to the wired communication field, specifically to the field of wired access communication technology, and particularly to a multiple access broadband wired access system with discontinuous mobility and a method thereof.

### DESCRIPTION OF THE RELATED ART

Communication access technologies may be divided into two types, wired access and wireless access. After long-term development, the advantages of wired access communication technology include: high communication quality; stable and reliable; immune to environmental conditions; private and secure; easier implementation than wireless mobile communication; healthy and no need to use high power radio frequency technology; extremely rich broadband wired access line resources everywhere, such as twisted-pair wires, coaxial cables or HFCs, category-5 cables, hybrid fiber/twisted-pair wires, pure fiber, and even power lines and so on; and overwhelming dominance of line bandwidth resources over wireless access, for example, the uplink/downlink packet data rate may be 1 Mbps/8 Mbps if ADSL technology is employed by twisted access, 6 Mbps˜13 Mbps/13 Mbps˜56 Mbps if VDSL technology is employed, and 10 Mbps for power line access technology (a recent study indicates the rate may be up to 200 Mbps within a range of 700 meters). Moreover, the access rates for Ethernet and fiber may be up to 100 Mbps, or even above 1 Gbps.

However, the conventional wired access technology mainly aims at providing fixed, still, separate, dedicated, and redundant access services to wire fixed user equipments, along with being used to wire fixed core networks. The number of the wired fixed user equipment are corresponding to an access port, access position and the core network, apart from the wired user equipment, do not belong to an user or user equipment, and can not be motive and carried with the wire terminal, and cannot be moved and carried with the wired terminals. All of this leads to a low traffic density for the wired access, the impossibility of sharing access bandwidth resources among multiple users, and a shortage in the economy of scale, thus causing comparatively high cost and no connection between the cost and traffic. As a result, the low economic benefit causes slow updating and development, along with an imbalance in the conventional wired access technology. For example, techniques such as traditional fixed telephone POTS, whose users account for 80%˜90% of the wire fixed access, have not varied during the past few decades, analog, along with fixed and still access technologies, are still being used. Although emerging broadband packet access technologies, such as Ethernet, xDSL, IP access, and so on, have many advantages, as the wired user equipment accessed, they are required to allocate an IP address thereto, which also corresponds to the packet access network equipment connected thereto and an access position. As the wired user equipment switches to a new access port and position, the packet access network is required to reallocate and set the IP address thereto; it is impossible to communicate using the same unique number as a wired fixed communication network, and to bi-directionally communicate with an existing PSTN and PLMN network. Therefore, the above-mentioned problems remain still unsolved. Problems with wired fixed access severely restrict the development of a full wired communication network, and the development speed and economic benefit of wired communication is apparently lagging behind those of wireless mobile access communication.

### SUMMARY OF THE INVENTION

One object of the invention is to provide a multiple access broadband wired access system with discontinuous mobility to overcome the above disadvantages of conventional wired access systems, thus enabling the wired access system to have discontinuous mobility and a multiple access feature.

Another object of the invention is to provide a multiple access broadband wired access method with discontinuous mobility to overcome the above disadvantages of the conventional wired access method, such as fixing, stillness, dedication, and so on, and to enable wired access to have a certain mobility and a multi-user sharing feature, thus improving the economic benefit of wired access communication.

The invention is a novel multiple access broadband wired access system with discontinuous mobility. To attain the above objectives, the multiple access broadband wired access system of the invention includes an end user access device, an access line, and an end office access device. The multiple access broadband wired access system of the invention complies with an access network definition defined by ITU-T G.902 and an access network general protocol, a layer reference model, and a functional architecture model recommended by ITU-T G.803. The end user access device is connected to a remote end office access device via the access line and this end office access device may be connected to multiple end user access devices distributed at a distance. These multiple end user access devices may be connected in a star shape, daisy chain, hybrid shape, and so on, and are then connected to the end office access device. The end user access device may be simultaneously accessed by multiple wired user equipments or/and wireless/wired multimode user equipments having fixed and unique numbers via connection lines or short-distance wireless technologies, such as Bluetooth, Wi-Fi, and so on. The end office access device directly accesses a corresponding core network via a circuit switched domain traffic and signaling interface, and a packet switched domain traffic and signaling interface, gaining access to other types of communication networks, such as PSTN/ISDN, PLMN, packet data network, the Internet, and so on, via a gateway, according to the requirements for practical network construction, and the requirements of the accessing user equipment for services and applications. Access lines connecting the end user access devices to the end office access device are wired line resources capable of providing broadband wired transmission, such as twisted copper wires, coaxial cables or HFCs, hybrid fiber/twisted copper wires such as FTTR, FTTN, FTTB, FTTC and so on, pure fiber such as FTTO or FTTH, Ethernet category 5 lines, even power lines and so on. The embodiments of the invention do not influence the original communication services and applications on the access line. If the access line is a twisted copper wire, and is connected to a traditional normal fixed POTS terminal that has been activated, the end user equipment may also be accessed to the POTS terminal, and the end office access device transfers the POTS service to a PSTN network.

To attain the above objectives, the multiple access broadband access system with discontinuous mobility of the invention comprises the following functions: multiplexing/de-multiplexing; cross-connection and broadband multiple access wired transmission; managing and controlling wired resources, such as taking access control and handover control over the user equipment; providing the user equipment and the core network with wired bearer services and wired access bearer services; broadcasting information for the multiple access broadband wired access system; encrypting/decrypting traffic and signaling; and supporting wired discontinuous mobility management. With the support and cooperation of the corresponding wired core network and user equipment, a wired user equipment or/and a wireless/wired multimode user equipment accessing the multiple access broadband wired access system of the invention, and having fixed and unique numbers, may switch access addresses and positions in the multiple access broadband wired access system of the invention, and employ the same wired access technology as the invention to switch to a coverage area of the multiple access broadband wired access system of the invention in other wired discontinuous mobile communication networks for a plurality of wired communication services and applications, without changing the fixed and unique number of the user equipment of the invention. Multiple user equipments accessing different ports of the same end user access device may share wired access resources, such as channels, bandwidths, and traffic data rates of the same access line, and communicate simultaneously without interference. Embodiments of the invention do not influence the original communication services and applications on the access line; if the access line is a twisted copper wire and is connected to a traditional normal fixed POTS terminal that has been activated, the POTS service may be separated from the end user access device and the end office access device via separators therein, transferred to a PSTN network via the end office access device, and simultaneously separated to the POTS terminal via the end user access device without influencing the normal operation of the POTS terminal. Moreover, the end user access devices 201a˜201n may further provide operating power to and recharge the accessing user equipment if power supply conditions permit. The above-mentioned core network is a wired mobile core network with discontinuous mobility, and can be accessed by the wired access system of the invention. The wired user equipment is a wired user equipment or/and a wireless/wired multimode user equipment having discontinuous mobility and a fixed and unique number. The wireless/wired multimode user equipment is a wireless/wired multimode user equipment combining one or more wireless technologies, comprising 2G technologies such as GSM/GPRS or IS-95A/B, and 3G technologies such as WCDMA, cdma2000 and TD-SCDMA, along with WLAN Wi-Fi and WiMax complying with 802.11x standards, with a wired discontinuous mobile technology.

Compared with the conventional wired access technology, the access system and the method thereof of the invention support wired discontinuous mobility of the wired user equipment or/and the wireless/wired multimode user equipment, the capability for multiple user equipments to share the wired access resources of the end user access devices and the access lines, such as channels, bandwidths, traffic data rate and so on, and the ability to simultaneously communicate without interference. The invention overcomes the disadvantages of conventional wired access, such as fixing, stillness, separation, dedication, redundancy, and so on, and improves the competitive advantage and economic benefit of wired access communication.

### BRIEF DESCRIPTION OF THE DRAWINGS

FIG. 1 is a theoretical diagram of the composition and structure of the access system of the invention;

FIG. 2 is a communication network system, including the access system of the invention, a wired user equipment, a wireless/wired multimode user equipment, and a core network;

FIG. 3 is an embodiment of an access application of a wired user equipment in a communication network, including the access system of the invention; and

FIG. 4 is an embodiment of an application for switching to an access position and a port for an accessing wired user equipment in a communication network, including the access system of the invention.

### DETAILED DESCRIPTION OF THE INVENTION

A detailed description of the access system and the method thereof according to the invention will be given below with reference to the accompanying drawings.

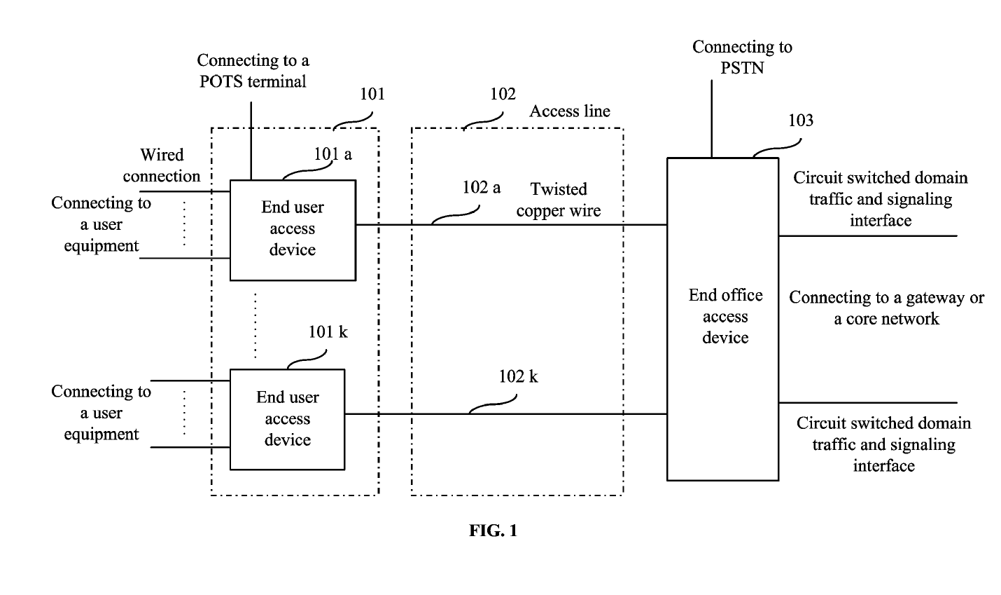

As shown in FIG. 1, the multiple access broadband wired access system supporting discontinuous mobility of the invention comprises an end user access device 101, an access line 102, and an end office access device 103. The end user access devices 101a˜101k are respectively connected to the remote end office access device 103 via corresponding access lines 102a˜102k, the end office access device 103 is correspondingly connected to the end user access devices 101a˜101k distributed at a distance via multiple access lines 102a˜102k. The connection in FIG. 1 is a star-shape, in other embodiments, other types of connections with the end office access device 103, such as a daisy chain, a hybrid shape, and so on, may also be employed as required. If the access line 102a is a twisted copper wire, and is connected to a traditional normal fixed POTS terminal that has been activated with communication services, the end user access device 101a may also be accessed by the POTS terminal, and the POTS service is transferred to the PSTN network via the end office access device 103.

Functions of the access system of the invention shown in FIG. 1 comprise managing and controlling wired access resources, such as taking access control and handover control over the user equipment, along with providing the user equipment and the core network with wired bearer services and wired access bearer services, and supporting wired discontinuous mobility management. The end office access device 103 and the end user access devices 101a˜101k cooperate with each other, to perform an initialization operation, comprising end-to-end testing and adaptation on the performance, such as the types, bandwidths, and transmission, of the access line resources 102a˜102k. The end user access devices 101a˜101k and the end office access device 103 perform uplink and downlink duplex transmission channel operations, such as construction, multiplexing, configuration, allocation, modulation/demodulation, synchronization, and so on, on the access line resources 102a˜102k via a multiplexing and a multiple access technology. The establishment and use of the uplink and downlink channels does not influence the original communication services on the access lines 102a˜102k, and the uplink and the downlink channels are divided into control channels and traffic channels. The end office access device 103 is responsible for controlling and managing the wired access resources connected thereto, and the end user access devices 101a˜101k cooperate therewith. The end office access device 103 operates, maintains, manages for itself, all the end user access devices 101a˜101k connected thereto, the access lines 102a˜102k, and the accessing user equipments. The wired access resources of the access lines 102a˜102k, such as channels, bandwidths, and traffic data rates, are shared among all the user equipments accessing thereto. The access system of the invention may dynamically adjust, configure, or reconfigure the wired access resources adaptively, or dynamically adjust and configure the wired access resources according to the requirements of the user equipments for services and applications. The transmission channels, the channel bandwidths, the transmission rates, and so on, which are provided to the user equipments by the access system, will vary based on the media types and lengths of the access lines 102a˜102k, the number of user equipments sharing the wired access resources, and the requirements for the services and applications. The access lines 102a˜102k connecting the end user access devices 101a˜101k to the end office access device 103 are existing wired line resources capable of providing broadband wired transmission, such as twisted copper wires, coaxial cables or HFCs, hybrid fiber/twisted copper wires such as FTTR, FTTN, FTTB, FTTC and so on, pure fiber such as FTTO or FTTH, Ethernet category 5 lines, even power lines and so on. The access line 102a is a twisted copper wire, and is connected to a traditional normal fixed POTS terminal that has been activated with the communication services. A POTS service may be separated from both the end user access device 101a and the end office access device 103 via separators therein without influencing normal operation of the POTS terminal. Moreover, the end user access devices 101a˜101k may also provide operating power to and recharge user equipment accessing thereto if power supply conditions permit.

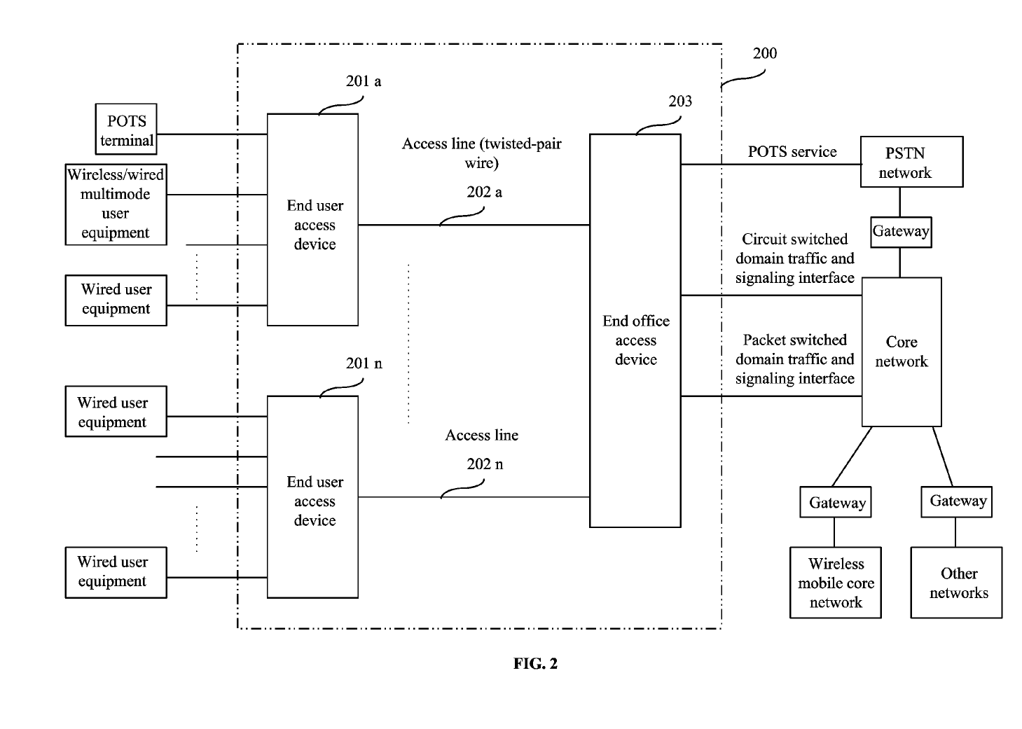

As shown in FIG. 2, a completed communication network architecture, including the wired access system 200 of the invention, wired user equipments accessing thereto, a wireless/wired multimode user equipment, and corresponding core network is illustrated.

The end user access devices 201a˜201n may be simultaneously accessed by multiple wired user equipments or/and wireless/wired multimode user equipments having their own fixed and unique numbers via multiple connection lines or short-distance wireless technology, and these user equipments will share the wired access resources and communicate simultaneously without interference. If the access line 202a is a twisted copper wire and is connected to a traditional normal fixed POTS terminal that has been activated, the end user access device 201a may also be simultaneously accessed by the POTS terminal without influencing the normal operation of the POTS service. The POTS service may be separated from the end user access device 201a and the end office access device 203 via separators therein, transferred to a PSTN network via the end office access device 203, and separated to the POTS terminal via the end user access device 201a.

The end office access device 203 may directly access a corresponding core network, and then other types of communication networks, such as PSTN/ISDN, PLMN, packet data network (PDN), the Internet and so on, via a gateway, according to the requirements of the user equipments accessing the end user access devices 201a˜201n for services and applications.

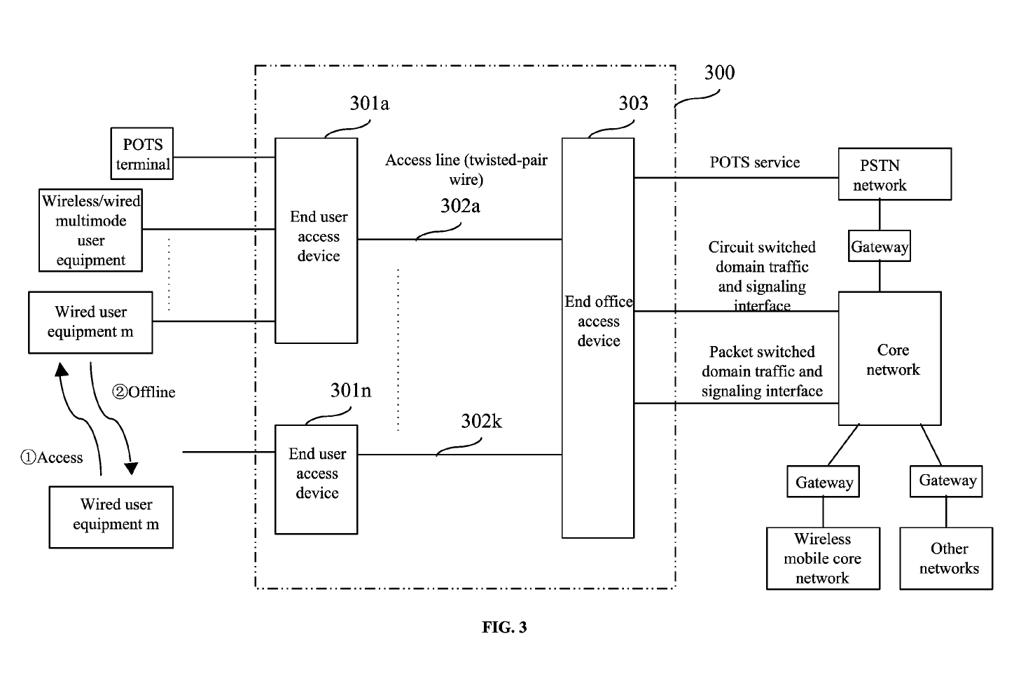

FIG. 3 illustrates a preferred embodiment of an access application for a wired user equipment m in a communication network, including the access system 300 of the invention. The wired user equipment m has a unique and fixed number, along with a wired discontinuous mobile communication function.

When the wired user equipment m accesses the wired access system 300 of the invention, the end user access device 301a uploads user information data, such as a user equipment number and so on, to the end office access device 303 via an uplink control channel of the access line 302a, and transmits relevant information to a corresponding core network for security management, comprising authentication and so on, via the end office access device 303. The end office access device 303 informs the wired user equipment m of the authentication result via a downlink control channel, and the multiple access broadband wired access system 300 will initially configure the wired access resources for the legal and entitled wired user equipment m. The end office access device 303 records the use status of the wired access resources for management, and the access system 300 reports access information, such as the end user access device 301a accessed by the user equipment, the access port, port position and so on, to a corresponding core network for revising and updating the information record of the wired user equipment m, and thereby managing discontinuous mobility thereof. The wired user equipment m is in an idle state at this point.

When the accessing wired user equipment m is in an idle state, the access system 300 will monitor and interoperate therewith via an uplink and a downlink control channel. As the wired user equipment m starts calling or is called, under control of the core network, the end office access device 303 controls the end user access device 301a to allocate the wired access resources of the access line 302a, such as uplink and downlink traffic channels, channel bandwidths, transmission rates, and so on, to the wired user equipment m according to the requirements of the wired user equipment m for services and applications, to establish wired access communication links and connections. It establishes communication links and connections for the wired user equipment m and the core network according to the requirements of the wired user equipment m for services and applications via a circuit/packet switched domain traffic and signaling interface; the user equipment is in an active connection state of traffic communication at this point. Since a multiple access technology is employed, other wired user equipments accessing the end user access device 301a may share the wired access resources, simultaneously establish connections, and communicate without interference. As the communication is terminated, the access system 300 of the invention will de-allocate the wired access resources, such as the uplink and the downlink traffic channels and the bandwidths assigned to the wired user equipment m, for use by other user equipments requiring communication, and the wired user equipment m will return to the idle state at this point. As the accessing wired user equipment m is disconnected from the end user access device 301a, the end user access device 301a reports to the end office access device 303 using the uplink control channel via the access line 302a, and the access system 300 will cancel all the wired access resources configured for the user equipment, delete the access information record of the user, and report offline information to the corresponding core network by the access system, for revising and updating the stored information record of the user equipment once again. The wired user equipment m is in an offline state at this point.

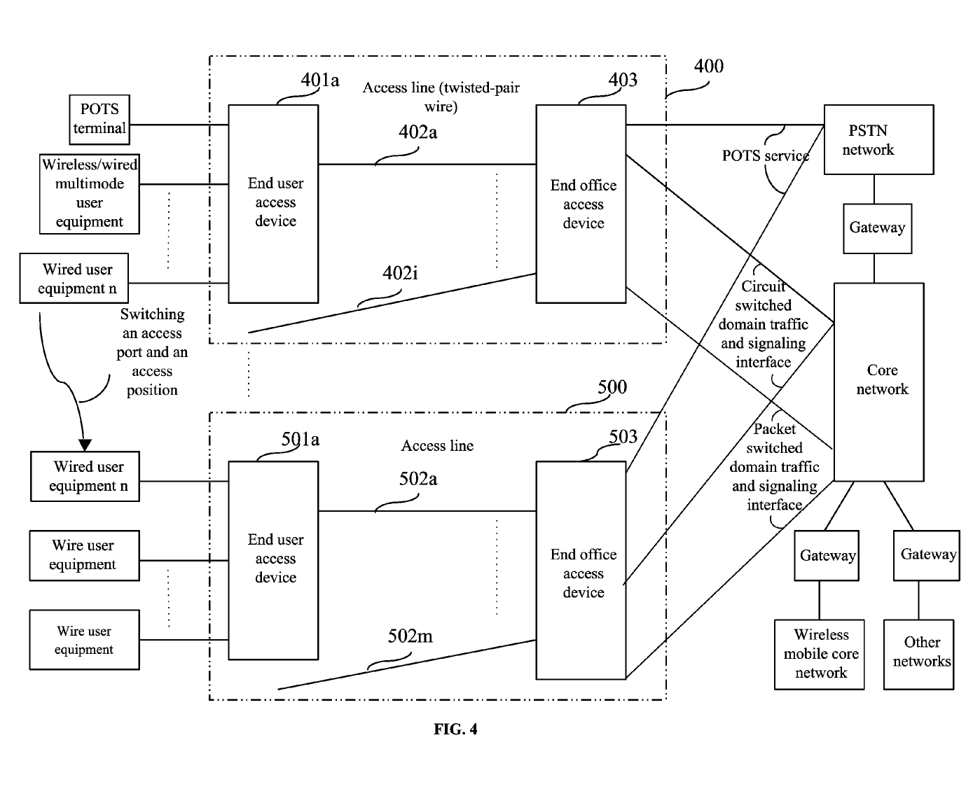

FIG. 4 illustrates an embodiment of switching and accessing a wired user equipment n that has accessed an end user access device 401a in the access system 400 of the invention by another end access device 501a in another multiple access broadband wired access system 500, namely a switching and access position application for an end user access device.

As the wired user equipment n is disconnected from the 400 of the invention, the end user access device 401a reports offline information thereof to the end office access device 403, using an uplink control channel via the access line 402a, and the access system 400 will cancel all wired access resources configured for the wired user equipment n and delete the relevant access information record of the wired user equipment n, uploading the offline information thereof to a relevant core network for revising and updating the original information record of the wired user equipment n. As the wired user equipment n moves to another place in which the access system 500 of the invention is located, and accesses another end user access device 501a, the end user access device 501a uploads user information, such as user equipment numbers and so on, to the end office access device 503 via an uplink control channel of the access line 502a, and transmits the relevant information to a corresponding core network via the end office access device 503, for security management comprising authentication and so on. The access system 500 will initially configure the wired access resources for the legal wired user equipment n. The end office access device 503 records and stores the use status of the wired access resources for managing the wired access resources, and the access system 500 reports access information, such as any end uer access device 501a accessed by the wired user equipment n, the access port, port position, and so on, to the corresponding core network to revise and update the stored information for the wired user equipment n, for managing discontinuous mobility thereof. At this point, the wired user equipment n is in an idle state, the access system 500 will monitor and interoperate with the accessing wired user equipment n via uplink and downlink control channels. As the wired user equipment n starts calling or is called, under control of the core network, the end office access device 503 controls the end user access device 501a to allocate the wired access resources of the access line 502a, such as uplink and downlink traffic channels, channel bandwidths, and transmission rates, to the wired user equipment n according to the requirements of the wired user equipment n for services and applications, to establish wired access communication links and connections. It establishes communication links and connections for the wired user equipment n and the core network according to the requirements of the wired user equipment n for the services and the applications via a circuit/packet switched domain traffic and signaling interface. The user equipment is in an active connection state of traffic communication at this point. As the communication is terminated, the access system 500 of the invention will de-allocate the allocated wired access resources, such as the uplink and the downlink traffic channels and the bandwidths, for use by other wired user equipments or/and wireless/wired multimode user equipments requiring communication. If the wired user equipment n belonging to a home network in another area roams to the access system 500 in a home area, the operational process of the access system 500 is the same as above.

Embodiments of the invention are not limited to access by a wired user equipment; the advantages of this invention may also be embodied by applying a wireless/wired multimode user equipment to the multiple access broadband wired access system of the invention.

It is believed that the embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A multiple access broadband wired access system with discontinuous mobility, wherein the multiple access broadband wired access system comprises an end user access device, an access line, and an end office access device, and complies with an access network definition defined by ITU-T G.902 and an access network general protocol, a layer reference model, and a functional architecture model recommended by ITU-T G.803.

2. The wired access system in accordance with claim 1, wherein
the end user access device is connected to a remote end office access device via the access line, the end office access device is connected to a plurality of end user access devices distributed at a distance, and the plurality of end user access devices is connected in the manner of a star shape, daisy chain shape, hybrid shape and so on, and are then connected to the end office access device; and
the end user access device is accessed by a plurality of wired user equipments or/and wireless/wired multimode user equipments having fixed and unique numbers, via connection lines or short-distance wireless technologies; and
the end office access device is able to access a relevant core network via a circuit switched domain traffic and signaling interface and a packet switched domain traffic and signaling interface, and then access other types of communication networks, such as PSTN/ISDN, PLMN, a packet data network, the Internet and so on, according to the requirements for practical network construction, and the requirements of the user equipment, which is accessed via the end user access device, for services and applications.

3. The wired access system in accordance with claim 2, wherein the access line connecting the end user access device to the end office access device is a wired line resource capable of providing broadband transmission.

4. The multiple access broadband wired access system in accordance with claim 2, wherein
the core network is a wired mobile core network with discontinuous mobility, which are accessed by the access system of the invention; and
the wired user equipment is a wired user equipment or/and a wireless/wired multimode user equipment having discontinuous mobility and a fixed and unique number. The wireless/wired multimode user equipment is a wireless/wired multimode user equipment combining one or more wireless technologies, comprising 2G technologies such as GSM/GPRS or IS-95A/B, and 3G technologies such as WCDMA, cdma2000 and TD-SCDMA, along with WLAN Wi-Fi and WiMax complying with 802.11x standards, with a wired discontinuous mobile technology.

5. The wired access system in accordance with claim 1, wherein
the access system comprises the following functions: multiplexing/de-multiplexing, cross-connection, and broadband multiple access wired transmission; and
the multiple access broadband wired access system further comprises the following functions: managing and controlling wired resources, such as taking access control and handover control over the user equipment, providing the user equipment and the core network with wired bearer services and wired access bearer services, and broadcasting information for the multiple access broadband wired access system, encrypting/decrypting traffic and signaling, and supporting wired discontinuous mobility management.

6. A multiple access broadband wired access method supporting discontinuous mobility, wherein with the support and cooperation of a corresponding wired core network and a user equipment, a wired user equipment, or/and a wireless/wired multimode user equipment, accessing the multiple access broadband wired access system of the invention, and having fixed and unique numbers, switches its access address and position in the multiple access broadband wired access system of the invention, and employs the same wired access technology as the invention to switch to a coverage area of the multiple access broadband wired access system of the invention in other wired discontinuous mobile communication networks, for multiple wired communication services and applications, without changing the fixed and unique number of the user equipment of the invention.

7. The access method in accordance with claim 6, wherein
a plurality of user equipments accessing different ports of the same end user access device shares wired access resources, such as the channels, bandwidths, and traffic data rates of the same access line, and communicate simultaneously without interference; and
the operation of an accessed wired user equipment or/and wireless/wired multimode user equipment will not influence the original communication services and applications on an access line; wherein
if the access line is a twisted copper wire and is connected to a traditional normal fixed POTS terminal that has been activated, a POTS service is separated from the end user access device and the end office access device via separators therein, transferred to a PSTN network via the end office access device, and simultaneously separated to the POTS terminal via the end user access device without influencing normal operation of the POTS terminal.

8. The access method in accordance with claim 6, comprising the following steps:
a) cooperation between the end user access device and the end office access device, to perform an initialization operation comprising end-to-end testing and adaptation on performance, such as types, bandwidths, and transmission, for the access line resources;
b) performing operations for an uplink and downlink duplex transmission channel, such as construction, multiplexing, configuration, allocation, modulation/demodulation, synchronization, and so on, on the access line resources for the end user access device and the end office access device via a multiplexing and a multiple access technology, with the establishment and use of the uplink and downlink channel not influencing the original communication services on the access line;
c) dividing the uplink and downlink channels of the multiple access broadband wired access system into control channels and traffic channels;
d) controlling and managing the wired access resources connected to the end office access device by the end office access device, and cooperation therewith from the end user equipment;
e) operating, maintaining and managing of the end office access device, all the end user access devices connected thereto, the access lines, and the accessing user equipments by the end office access device;
f) sharing the wired access resources of the access line, such as transmission channels, channel bandwidths, transmission rates, and so on, among all the accessing user equipments, and dynamically adjusting, configuring, and reconfiguring the wired access resources adaptively, or dynamically adjusting and configuring the wired access resources according to the requirements of the user equipments for services and applications by the access system; and
g) the transmission channels, the channel bandwidths and the transmission rates and so on, provided to the user equipments by the access system are different based on the media types and lengths of the access lines, the number of user equipments sharing the wired access resources, and requirements for the services and applications.

9. The multiple access broadband wired access method in accordance with claim 6, further comprising the following steps:
a) uploading user information data such as a user equipment number and so on to the end office access device via the uplink control channel of the access line, and transmitting relevant information to a corresponding core network for security management comprising authentication and so on via the end office access device by the end user access device as the user equipment accesses the wired access system of the invention;
b) informing the user equipment of the authentication result via the downlink control channel by the end office access device, and initially configuring the wired access resources for a legal and entitled user equipment through the access system.
c) recording the use status of the wired access resources in the end office access device for management, and reporting access information, such as the end user access device accessed by the user equipment, the access port, port position and so on, to the corresponding core network through the access system for revising and updating the stored information for the user equipment, and thereby managing discontinuous mobility thereof;
d) monitoring and interoperating with the accessing user equipment via the uplink and downlink control channel by the access system when the accessing user equipment is in an idle state;
e) under control of the core network, controlling the end user access device to allocate wired access resources, such as uplink and downlink traffic channels, channel bandwidths, and transmission rates to the wired user equipment according to the requirements of the wired user equipment for services and applications by the end office access device when the wired user equipment starts calling or is called, to establish wired access communication links and connections;
f) establishing communication links and connections for the user equipment and the core network via a circuit/packet switched domain traffic and signaling interface according to the requirements of the user equipment for services and applications, and entering an active connection state of traffic communication by the user equipment;
g) de-allocating wired access resources, such as the uplink and downlink traffic channels, the bandwidths and so on, by the access system when the communication is terminated, for use by other user equipments requiring communication, and returning the user equipment to the idle state at this point.
h) disconnecting from the end user access device by the accessing user equipment, reporting to the end office access device, using the uplink control channel via the access line by the end user access device, and canceling all the wired access resources configured for the user equipment and deleting the access information record of the user by the access system; and
i) reporting offline information to the corresponding core network by the access system, for revising and updating the stored information record of the user equipment once again, with the user equipment in an offline state at this point.

10. The wired access method in accordance with claim 6, wherein the end user access device further provides operating power to and recharge the accessing user equipment if power supply conditions permit.
